(19) United States
(12) Patent Application Publication
(10) Pub. No.: US 2026/0111153 A1
(43) Pub. Date: Apr. 23, 2026

(54) DATA STORAGE APPARATUS USING VIRTUAL ADDRESS, OPERATING METHOD THEREOF, AND MEMORY CONTROLLER THEREFOR

(71) Applicant: SK hynix Inc., Icheon-si (KR)

(72) Inventors: Ik Joon SON, Icheon-si (KR); Dong Hwan Koo, Icheon-si (KR); Han Bin Lee, Icheon-si (KR)

(21) Appl. No.: 19/071,558

(22) Filed: Mar. 5, 2025

(30) Foreign Application Priority Data
Oct. 21, 2024 (KR) 10-2024-0144075

(51) Int. Cl. G06F 3/06

(52) U.S. Cl. CPC G06F 3/0665; G06F 3/0604; G06F 3/0655; G06F 3/0679

(57) ABSTRACT

A data storage apparatus includes a memory controller configured to access a memory device based on an address mapping table. The address mapping table includes a logical-virtual address table and a virtual-physical address table. When an error occurs in a page of the memory device, the memory controller searches for a virtual address related to that page with reference to the virtual-physical address table without accessing the logical-virtual address table, and registers the searched virtual address in a reuse table.

### CROSS-REFERENCES TO RELATED APPLICATION

The present application claims priority under 35 U.S.C. § 119(a) to Korean Patent Application Number 10-2024-0144075, filed on Oct. 21, 2024, in the Korean Intellectual Property Office, which is incorporated herein by reference in its entirety.

### BACKGROUND

### 1. Technical Field

Various embodiments may generally relate to an electronic apparatus, and more particularly, to a data storage apparatus using a virtual address, an operating method thereof, and a memory controller therefor.

### 2. Related Art

A data storage apparatus may store data in a memory device or read data stored in the memory device and provide the read data to an external apparatus, in response to a request of the external apparatus.

A logical address which is an address used in the external apparatus may be different from a physical address which is an address used in the memory device. Accordingly, the data storage apparatus may perform address translation, for example, address mapping between the logical address and the physical address.

The memory device such as a flash memory device may have a space, which is not accessible by a memory controller, such as a bad block, and thus continuity of the physical address mapped to the logical address may not be guaranteed.

The memory controller may achieve the effect of sequentially or simultaneously accessing non-adjacent regions of the memory device using a continuous range of virtual addresses.

Because the range of the virtual address is limited, when an inaccessible region occurs during use of the memory device, the virtual address allocated to the corresponding region should be quickly retrieved and reused.

### SUMMARY

In an embodiment of the present disclosure, a data storage apparatus may include a memory device and a memory controller configured to control the memory device. The memory controller may include an address mapping manager configured to access the memory device based on an address mapping table including a logical-virtual address table and a virtual-physical address table, and when an error occurs in a first page of the memory device, search for a virtual block address related to the first page with reference to the virtual-physical address table without accessing the logical-virtual address table and register a virtual address including a searched virtual block address in a reuse table.

In an embodiment of the present disclosure, a memory controller may include: an address mapping table storage including a logical-virtual address table, a virtual-physical address table, and a reuse table; an address conversion circuit configured to generate a first virtual address corresponding to a first logical address of data to be written in a memory device, the first virtual address comprising a pair consisting of a first virtual block address and a first physical page address, store the first virtual address in the logical-virtual address table mapping the first virtual address to the first logical address when a logical address is not allocated to the first virtual address, and store the first virtual block address in the virtual-physical address table by mapping the first virtual block address to a first physical block address; and a reuse circuit configured to receive an error physical block address of the memory device, search for an error virtual block address mapped to the error physical block address with reference to the virtual-physical address table without accessing the logical-virtual address table, and register an error virtual address including a searched error virtual block address in the reuse table.

In an embodiment of the present disclosure, an operating method of a data storage apparatus including a memory device and a memory controller configured to access the memory device based on an address mapping table including a logical-virtual address table and a virtual-physical address table, the method comprising: the memory controller searching for, when an error occurs in a first page of the memory device, a virtual block address related to the first page with reference to the virtual-physical address table without accessing the logical-virtual address table; and the memory controller registering a virtual address including a searched virtual block address in a reuse table.

These and other features, aspects, and embodiments are described in more detail below.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 illustrates a configuration of a data processing system according to an embodiment of the present disclosure;

FIG. 2 is a conceptual diagram illustrating a memory device according to an embodiment of the present disclosure;

FIG. 3 illustrates a configuration of logical-virtual address mapping table according to an embodiment of the present disclosure;

FIG. 4 illustrates a configuration of a virtual-physical address mapping table according to an embodiment of the present disclosure;

FIG. 5 illustrates an address searching concept according to an embodiment of the present disclosure;

FIG. 6 illustrates an error virtual address processing process according to an embodiment of the present disclosure;

FIG. 7 illustrates a configuration of an address mapping manager according to an embodiment of the present disclosure;

FIGS. 8 and 9 are conceptual diagrams illustrating a virtual address reuse process according to an embodiment of the present disclosure; and

FIGS. 10, 11, and 12 are flowcharts illustrating respective components of a virtual address reuse process according to an embodiment of the present disclosure.

### DETAILED DESCRIPTION

Various embodiments of the present teachings are described in detail with reference to the accompanying drawings. The drawings include schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present teachings as defined in the appended claims.

The present teachings may be described herein with reference to illustrations of idealized embodiments of the present teachings. However, embodiments of the present teachings should not be construed as limiting the present teachings. Although a few embodiments of the present teachings are shown and described, it will be appreciated by those of ordinary skill in the art that changes may be made in these embodiments without departing from the principles and spirit of the present teachings.

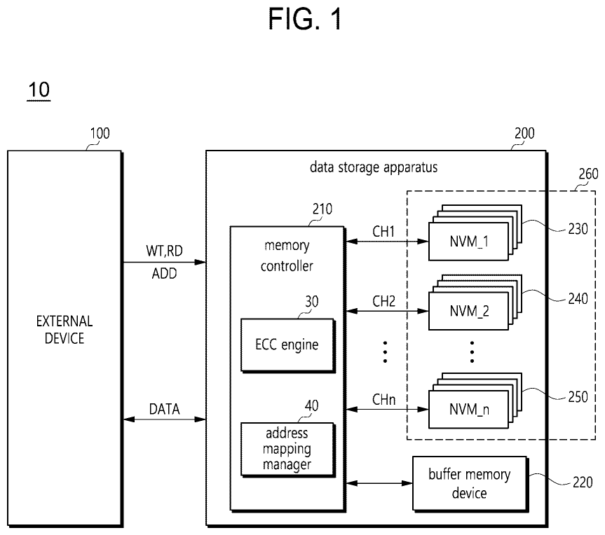

FIG. 1 illustrates a configuration of a data processing system 10 according to an embodiment.

The data processing system 10 may include an external apparatus 100 and a data storage apparatus 200.

The external apparatus 100 may include at least one processor. The external apparatus 100 may be a processor itself or an electronic apparatus or electronic system including the processor.

The data storage apparatus 200 may include a memory controller 210, a buffer memory device 220, and a memory device 260. The memory device 260 may include at least a plurality of nonvolatile memory devices 230, 240, and 250.

The external apparatus 100 may transmit a write request including a write command WT, an address ADD, and write data DATA to the data storage apparatus 200 to record data. In response to the write request, the memory controller 210 of the data storage apparatus 200 may control the memory device 260 to program the write data into the memory device 260.

The external apparatus 100 may transmit a read request including a read command RD and an address ADD to the data storage apparatus 200 to read data. The memory controller 210 of the data storage apparatus 200 may control the memory device 260 to read read-requested data DATA from the memory device 260 and transmit the read data DATA to the external apparatus 100.

The data storage apparatus 200 may read data from the memory device 260 or write data in the memory device 260 to perform the read and write requests of the external apparatus 100 as well as to perform an internal operation of the data storage apparatus 200. The internal operation may include a house keeping operation which is performed regardless of a request of the external apparatus 100 so as to efficiently use a storage space of the memory device 260 or to ensure the reliability of data stored in the memory device 260, for example, garbage collection, wear leveling, read reclaim, and the like.

The buffer memory device 220 may temporarily store data transmitted and received between the external apparatus 100 and the data storage apparatus 200 or between the memory controller 210 and the memory device 260 in the write or read operation.

The memory controller 210 may provide interfacing between the external apparatus 100 and the data storage apparatus 200.

The memory controller 210 may include an error correction code (ECC) engine and an address mapping manager 40.

The ECC engine 30 may detect and correct an error in data accessed by the memory controller 210. In addition, when an uncorrectable error correction code (UECC) error occurs in a specific memory region, the ECC engine 30 may provide an error physical address which is a physical address of the corresponding memory region to the address mapping manager 40. The physical address may be a pair consisting of a physical block address and a physical page address.

The address mapping manager 40 may convert the logical address provided from the external apparatus 100 into the virtual block address and the physical address. In addition, the address mapping manager 40 may receive the error physical address from the ECC engine and register an error virtual address which is a virtual address allocated to the error physical address in the reuse table. The virtual address may be a pair consisting of the virtual block address and the physical page address.

When a virtual address (comprising a virtual block address, physical page address pair) that is to be mapped to a logical address is generated, the address mapping manager 40 may confirm whether or not the generated virtual address is registered in the reuse table and may immediately reuse the generated virtual address.

When an error virtual address is registered in the reuse table, the address mapping manager 40 may activate a reuse flag. The address mapping manager 40 may subsequently remove the reused error virtual address from the reuse table, and when the error virtual address does not exist in the reuse table, the address mapping manager 40 may inactivate the reuse flag. The address mapping manager 40 may avoid performing an unnecessary access to the reuse table during address conversion by checking the reuse table only when the reuse flag is activated.

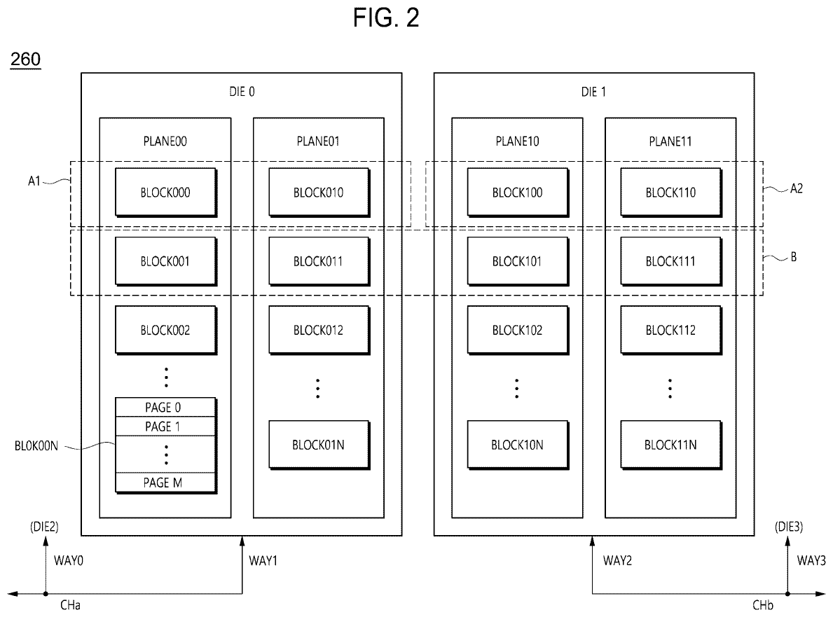

FIG. 2 is a conceptual diagram of a nonvolatile memory device 260 according to an embodiment.

The nonvolatile memory device 260 may include at least one die (here, dies DIE0, DIE1, DIE2, and DIE3, where dies DIE2 and DIE3 are not fully shown but may be substantially similar to dies DIE 1 and DIE 2) and each of the dies DIE0 to DIE3 may include at least one plane (here, planes PLANE00 and PLANE01 in die DIE0 and planes PLANE10 and PLANE11 in die DIE1. Each of the planes PLANE00/PLANE01 and PLANE10/PLANE11 may include a plurality of memory blocks BLOCK000˜BLOCK00N, BLOCK010˜BLOCK01N, BLOCK100˜BLOCK10N, and BLOCK100˜BLOCK11N. Each of the memory blocks BLOCK 000˜BLOCK00N, BLOCK 010˜BLOCK01N, BLOCK00/18 BLOCK10N, and BLOCK110˜BLOCK11N may include a plurality of pages PAGE 0 to PAGE M.

The nonvolatile memory device 260 may perform input/output of data through channels CHa and CHb. Each of the channels Cha and CHb may perform the data input/output through an interleaving process. Each of channels CHa and CHb may be branched into a plurality of ways (in the illustrated example, ways WAY0 and WAY1 for channel CHa and ways WAY2 and WAY3 for channel CHb) shared with the channels CHa and CHb to be coupled to each of the die DIE0 to DIE3.

In the example of FIG. 2, each of the dies DIE0/DIE2 DIE1/DIE3 are coupled to one of the ways WAY0 to WAY3 branched from the channels CHa and CHb, but the configuration of the memory device 120 is not limited thereto.

The memory controller 210 may group simultaneously selectable blocks among the plurality of memory blocks to form a super block.

The super block may be configured of a combination of the simultaneously selectable blocks, for example, a first type of super blocks A1 and A2 configured by grouping memory blocks included in different planes from each other within the same die, a second type of super block B configured by grouping memory blocks included in different planes from each other within the plurality of dies, or the like.

Unique physical addresses may be assigned to the memory blocks BLOCK000˜BLOCK00N, BLOCK010˜BLOCK01N, BLOCK100˜BLOCK10N, and BLOCK110˜BLOCK11N and the pages PAGE 0 to PAGE M within each block, respectively.

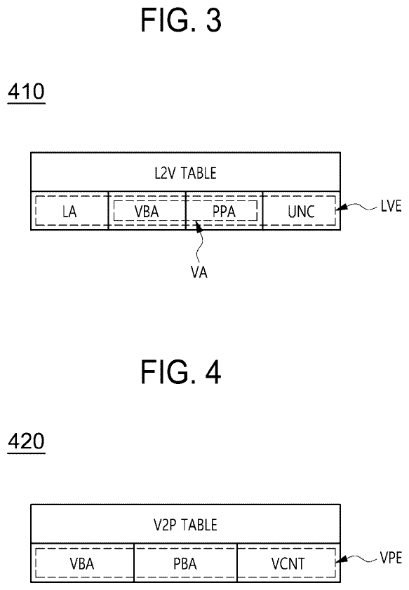

FIG. 3 is a configuration diagram of a logical-virtual (L2V) address mapping table 410 according to an embodiment.

The logical-virtual address table 410 may include a plurality of unit logical-virtual (LV) entries LVE each of which includes a logical address LA, a virtual address VA, and a valid tag UNC.

The logical address LA may be an address used by the external apparatus 100.

The virtual address VA may be a pair consisting of a virtual block address VBA allocated to the logical address LA by the address mapping manager 40 and a physical page address PPA. The physical page address PPA may be a specific physical page address within a specific physical block of the memory device 260 allocated to the virtual block address VBA by the address mapping manager 40.

The valid tag UNC may be set to a specific value when an error, for example, an UECC error, occurs in a page corresponding to the physical page address PPA.

FIG. 4 is a configuration diagram of a virtual-physical (V2P) address mapping table 420 according to an embodiment.

The virtual-physical address table 420 may include a plurality of unit virtual-physical (VP) entries VPE each of which includes the virtual block address VBA, a physical block address PBA, and a valid count VCNT.

The physical block address PBA may be a specific physical block address of the memory device 260 allocated to the virtual block address VBA by the address mapping manager 40. When searching for the physical address allocated to the logical address LA, the address mapping manager 40 may search for the virtual block address VBA and the physical page address PPA from the logical-virtual address table 410 shown in FIG. 3, and search for the physical block address PBA mapped to the virtual block address VBA from the virtual-physical address table 420 shown in FIG. 4.

The valid count VCNT may indicate the number of valid pages among the physical pages mapped to the virtual block address VBA of the corresponding VP entry VPE. The valid count VCNT of 0 (zero) may mean that no valid page mapped to the corresponding virtual block exists. Accordingly, the virtual block address VBA for which the valid count VCNT is 0 (zero) may be mapped to another physical address (physical block address, physical page address).

As data is programmed in, deleted from, and moved in the memory device 260 according to the write request of the external apparatus 100 or the house keeping operation of the data storage apparatus 200, the address mapping manager 40 may read and update the logical-virtual address table 410 and the virtual-physical address table 420. To do this, the address mapping manager 40 may further generate a virtual-logical address table as a reverse table of the logical-virtual address table and a physical-virtual address table as a reverse table of the virtual-physical address table.

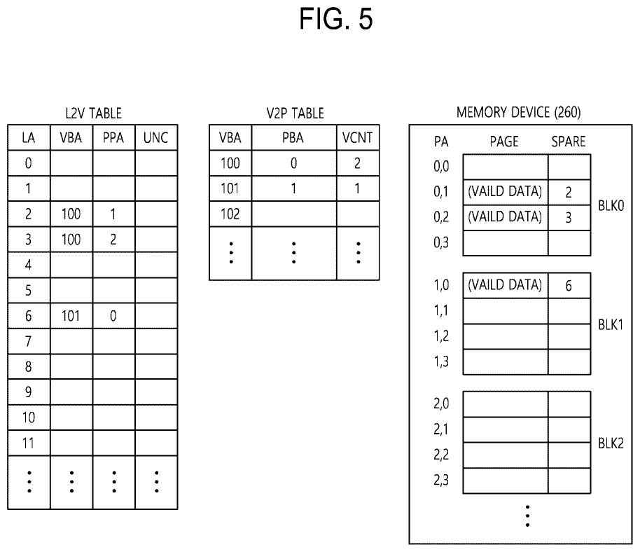

FIG. 5 illustrates an address search concept according to an embodiment.

Referring to FIG. 5, to search for a physical address PA corresponding to a logical address LA “3”, the address mapping manager 40 may confirm that the mapping information of the logical address LA “3” is valid with reference to the valid tag UNC of the logical address LA “3” from the logical-virtual address table L2V TABLE. The address mapping manager 40 may obtain the virtual block address VBA “100” and the physical page address PPA “2” corresponding to the logical address LA “3” from the logical-virtual address table L2V TABLE.

The address mapping manager 40 may access the virtual-physical address table V2P TABLE to obtain the physical block address PBA “0” based on the virtual block address VBA “100” obtained from the logical-virtual address table L2V TABLE.

Accordingly, the memory controller 210 may access the memory device 260 using the physical address PA (0,2) wherein the physical block address PBA is “0”, and the physical page address PPA is “2”.

The memory device 260 may include a plurality of memory blocks BLK0, BLK1, and BLK2 each of which includes a plurality of pages PAGE, and a unique address may be associated with each of the blocks BLK0, BLK1, and BLK2 and each page PAGE. The logical address LA mapped to the corresponding page PAGE may be stored in a spare region SPARE of each page PAGE.

Because “3” is recorded in the spare region SPARE of the page instructed by the physical address PA (0,2), it can be determined that the mapping information between the logical address LA “3” and the physical address PA (0,2) is correct. The mapping information may be recovered using the information stored in the spare region SPARE in a reset operation after sudden power off.

Portions of the memory device 260 may wear out as the number of uses is increased, and the UECC fail may occur due to power failure, data loss, a surrounding environment, a control error, and the like. The range of virtual addresses available to be allocated may be limited, and therefore the virtual address allocated to failed page having the UECC fail should be immediately retrieved and reused.

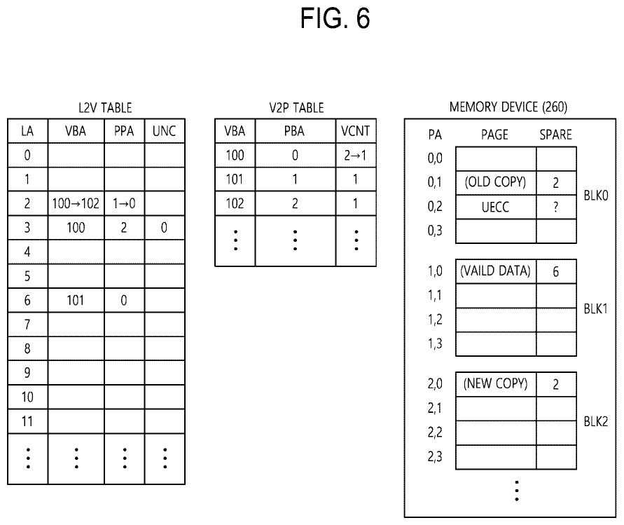

FIG. 6 is a diagram explaining an error virtual address processing process according to an embodiment.

Referring to FIG. 6, a UECC fail may occur in a page corresponding to the physical address PA (0,2). When the UECC fail occurs, because the data of the spare region SPARE may not be recoverable, the logical address LA mapped to the corresponding page may not be confirmable using information from the spare region SPARE. Accordingly, when the UECC fail occurs, the address mapping manager 40 may search the virtual-physical address table V2P TABLE and the logical-virtual address table L2V TABLE to find the LV entry LVE corresponding to the physical address PA (0,2). The address mapping manager 40 may then set the valid tag UNC to indicate that the corresponding entry is UECC-failed. The virtual address having the valid tag UNC that is set as to the specific value indicating UECC-failed may be treated as an allocation-released address. This indicates that the virtual address having the valid tag UNC that is set as the specific value may be reused, and when the virtual address is reused, the valid count VCONT of the corresponding VP entry VPE in the virtual-physical address table V2P TABLE may be updated.

When the UECC fail occurs in a read operation corresponding to a read request from the external apparatus 100, because the logical address LA is already known, the address mapping manager 40 may quickly search the logical-virtual address table L2V TABLE for the corresponding LV entry. However, when the UECC fail occurs during an internal operation such as garbage collection, an operation of searching through a massive amount entries of logical-virtual address table L2V TABLE has to be performed to set the valid tag UNC, and several seconds to tens of seconds for the searching operation may be required.

Further, even when data stored in the normal physical page PA (0,1) of the physical block BLK0 including the error-occurred page moves to another physical block BLK2, because the valid count VCNT of the virtual block address “100” is “1”, this is, because the valid count VCNT of the virtual block address “100” is not “0 (zero)”, the corresponding virtual address may not be immediately reused. For example, to reuse the virtual block address “100” to which the error physical address PA (0,2) is mapped, a delay corresponding to the time for accessing the logical-virtual address table L2V TABLE to confirm whether or not the virtual block address “100” is a reusable virtual address may be required.

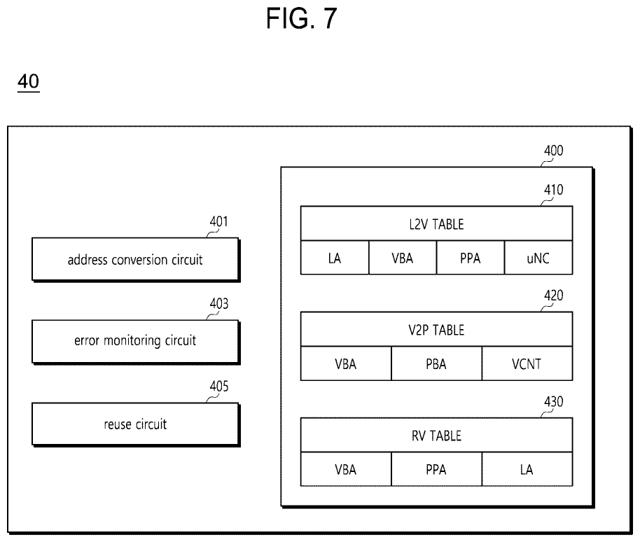

To avoid this delay and more quickly reuse the virtual block address, the address mapping manager 40 may be configured, for example, as in FIG. 7.

FIG. 7 is a configuration diagram of an address mapping manager 40 according to an embodiment.

The address mapping manager 40 may include an address conversion circuit 401, an error monitoring circuit 403, a reuse circuit 405, and an address mapping table storage 400.

The address conversion circuit 401 may generate the virtual block address and the physical address (physical block address, physical page address) to be mapped to a logical address of data to be written, and store mapping information between the logical address and the virtual address (comprised of a virtual block address VBA), physical page address (PPA) pair, and which may be referred to as “virtual address (VBA, PPA)” herein) and mapping information between the virtual block address and the physical block address in the address mapping table storage 400. For example, so as to avoid duplicate allocation of the virtual address, the address conversion circuit 401 may allocate a first virtual address to a first logical address only when a logical address is not allocated to the first virtual address generated corresponding to the first logical address.

The address conversion circuit 401 may search for the address mapping table storage 400 based on a logical address of data to be read to acquire the physical address.

The address mapping table storage 400 may store the logical-virtual address table L2V TABLE 410, the virtual-physical address table V2P TABLE 420, and the reuse table RV TABLE 430.

The logical-virtual address table 410 may include a logical address LA field, a virtual address (VBA, PPA) field, and a valid tag UNC field as described with reference to FIG. 3.

The virtual-physical address table 420 may include a virtual block address VBA field, a physical block address PBA field, and a valid count VCNT field as described with reference to FIG. 4.

The reuse table 430 may include a virtual address (VBA, PPA) field and a logical address LA field.

The error monitoring circuit 403 may receive a physical address of a page where an error occurred (an error-occurred page) from the ECC engine 30. The error monitoring circuit 403 may search for the virtual block address VBA allocated to the physical block address PBA of the physical block including the error-occurred page (i.e. the error-occurred virtual block address VBA) from the virtual-physical address table 420 of the address mapping table storage 400, and register the virtual address, which is a pair consisting of the virtual block address VBA and the physical page address PPA, corresponding to the error-occurred page in the reuse table 430.

As the address conversion circuit 401 generates the virtual block address to be mapped to the logical address, the reuse circuit 405 may confirm whether the generated virtual block address is a virtual block address registered in the reuse table 430. When it is confirmed that the generated virtual block address is registered in the reuse table 430, the address conversion circuit 401 may reuse the generated virtual block address by allocating the generated virtual block address to the corresponding logical address, and update the mapping information in the logical-virtual address table 410, the virtual-physical address table 420, and the reuse table 430 by mapping the physical address.

Accordingly, when the error-occurred virtual block address VBA is reused, a newly allocated logical address LA may be mapped to that virtual block address VBA and stored in the reuse table 430.

When the generated virtual block address is not registered in the reuse table 430, the address conversion circuit 401 may allocate the generated virtual block address to the corresponding logical address, and update the mapping table storage 400 by mapping the physical address.

The reuse circuit 405 may confirm whether or not the virtual block address corresponding to the logical address LA of the data to be read is a virtual block address registered in the reuse table 430. When it is confirmed that the virtual block address VBA and the physical page address PPA of the logical address to be read are registered in the reuse table 430, the reuse circuit 405 may confirm whether or not the logical address LA to be read coincides with the logical address LA mapped to the virtual block address VBA of the reuse table 430.

The logical address stored in the logical address LA field of the reuse table 430 may not exist or may be different from the logical address to be read. This case may correspond to a read request for a UECC-failed page. The reuse circuit 430 may access the logical-virtual address table 410 according to the virtual address (VBA, PPA) registered in the reuse table 430, store a specific value in the valid tag UNC field of the LV entry LVE related to the logical address to be read to release the address allocation, and delete the virtual address from the reuse table 430.

When the logical address stored in the logical address LA field of the reuse table 430 coincides with the logical address to be read, the reuse circuit 430 may determine that the virtual block address VBA is reused and maintain the virtual address (VBA, PPA) in the reuse table 430.

In one embodiment, the error monitoring circuit 403 may activate the reuse flag when the virtual address (VBA, PPA) is registered in the reuse table 430. The error monitoring circuit 403 may inactivate the reuse flag when all the virtual block addresses VBA registered in the reuse table 430 are deleted.

The reuse circuit 405 may avoid performing unnecessary accesses of the reuse table in address conversion by checking the reuse table only when the reuse flag is activated.

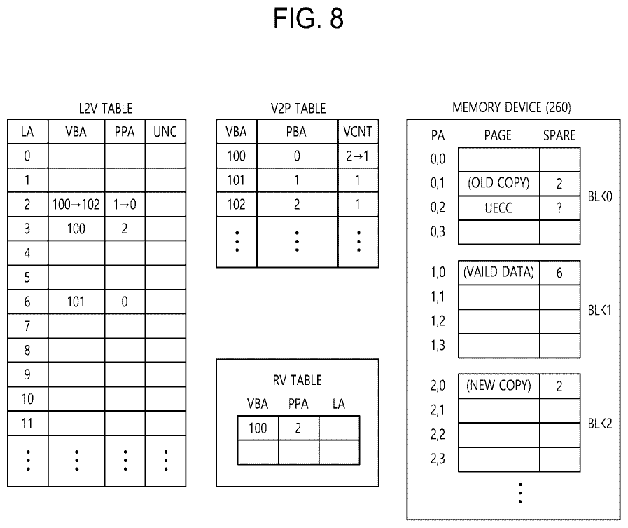

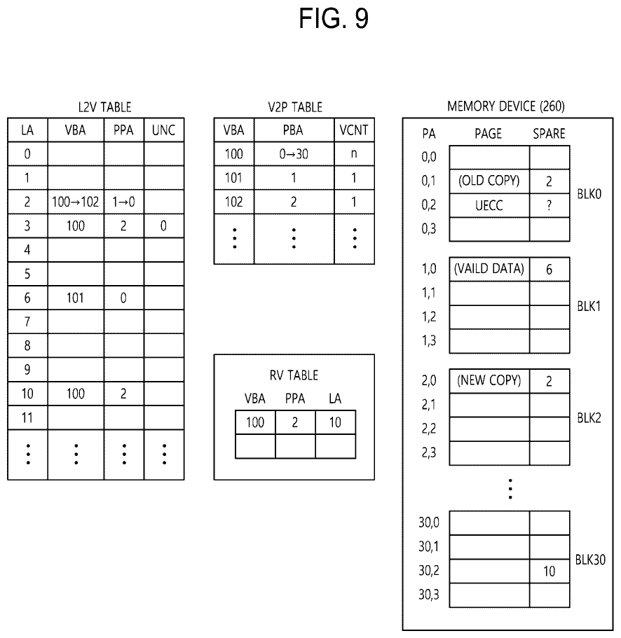

FIGS. 8 and 9 are conceptual diagrams explaining a virtual address reuse process according to an embodiment.

Referring to FIG. 8, the UECC fail may occur in the page instructed by the physical address PA (0,2). When the UECC fail occurs, the data of the spare region SPARE may not be recoverable, and thus the logical address LA may not be able to be confirmed using information from the spare region SPARE. The address mapping manager 40 may search the virtual-physical address table V2P TABLE based on the error-occurred physical address PA (0,2) to acquire the virtual block address VBA “100” corresponding to the physical block address PBA “0”.

The address mapping manager 40 may store the acquired virtual block address VBA “100” and the physical page address PPA “2” in the reuse table RV TABLE. Because the virtual block address VBA “100” is not yet reused, the logical address LA field corresponding thereto may be in an empty state.

To write data in the memory device 260 according to the request of the external apparatus 100 or according to the internal operation of the data storage apparatus 200, the address mapping manager 40 may generate the virtual address to be mapped to the logical address of the data to be written.

When the virtual block address VBA generated corresponding to the logical address “10” is “100” and the physical address PA is “30, 2”, the address mapping manager 40 may confirm whether or not the generated virtual block address VBA exists in the reuse table RV TABLE.

When it is confirmed that the generated virtual block address VBA is an address registered in the reuse table RV TABLE, the address mapping manager 40 may confirm a logical address LA mapped to the virtual block address VBA of the reuse table RV TABLE.

As illustrated in FIG. 8, because the logical address LA field for the virtual block address VBA “100” of the reuse table RV TABLE is empty, the address mapping manager 40 may reuse the virtual block address VBA “100” by allocating the virtual address (VBA, PPA) “100, 2” to the corresponding logical address LA “10”, and update the mapping information in the logical-physical address table L2V TABLE, the virtual-physical address V2P table, and the reuse table RV TABLE.

When the virtual block address VBA “100” is reused, the newly allocated logical address LA “10” may be mapped to the virtual block address VBA “100” and stored in the reuse table RV Table as illustrated in FIG. 9. The physical page address of the reuse table RV TABLE may be updated or may not be updated.

When the virtual address corresponding to the logical address to be read is registered in the reuse table RV TABLE and a logical address which is the same as the logical address to be read is mapped, the address mapping manager 40 may maintain the virtual block address VBA and the mapping information thereof in the reuse table RV TABLE.

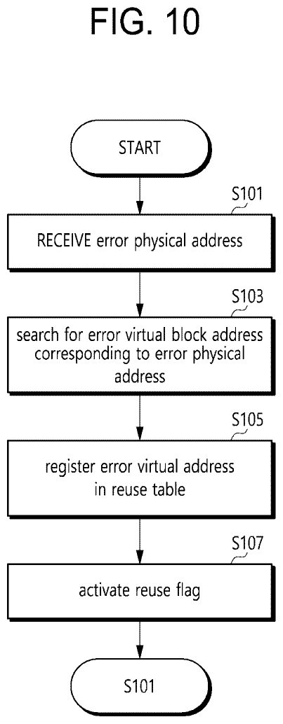

FIGS. 10 to 12 are flowcharts explaining a virtual address reuse process according to an embodiment.

FIG. 10 is a flowchart explaining an error virtual address registration process according to a UECC fail occurrence.

The address mapping manager 40 may receive an error physical address including a physical block address and a physical page address, which corresponds to an error-occurred page of the memory device 260, from the ECC engine 30 (S101). The address mapping manager 40 may search for a virtual block address VBA allocated to the physical block address of the error-occurred page from the virtual-physical address table 420 of the address mapping table storage 400 (S103).

The address mapping manager 40 may register the virtual address, which comprises a pair consisting of the searched virtual block address and the physical page address mapped thereto, in the reuse table 430 (S105).

According to the implementations, the address mapping manager 40 may activate the reuse flag when the error virtual address is registered in the reuse table 430 (S107), but embodiments are not limited thereto.

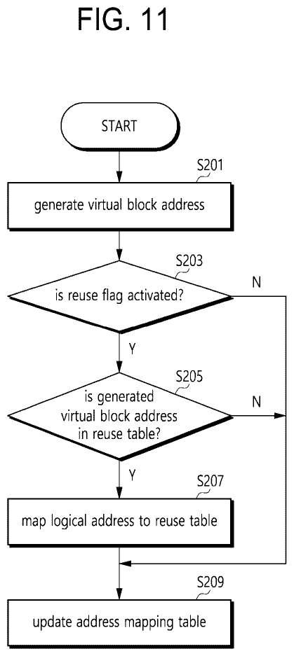

FIG. 11 is a flowchart explaining a virtual address processing process performed in a write operation.

As a virtual block address to be mapped to a logical address is generated (S201), the address mapping manager 40 may confirm whether or not the reuse flag is activated (S203). The reuse flag confirming process (S203) may be omitted in a mode in which the reuse flag is not used, in which case the process may proceed directly from S201 to S205.

When it is confirmed that the reuse flag is activated (S203:Y), the address mapping manager 40 may confirm whether or not the generated virtual block address is a virtual address registered in the reuse table 430 (S205).

When it is confirmed that the generated virtual block address is registered in the reuse table 430 (S205:Y), the address mapping manager 40 may reuse the generated virtual block address by allocating the generated virtual block address to the corresponding logical address, and store the generated virtual block address in the reuse table by mapping a logical address to the generated virtual block address (S207). Accordingly, when the virtual block address is reused, a newly allocated logical address may be mapped to the virtual block address and stored in the reuse table 430.

The address mapping manager 40 may store the updated mapping information in the address mapping table storage 400 (S209).

When it is confirmed that the generated virtual block address is not registered in the reuse table 430 (S205:N) or when no reusable virtual address exists and the reuse flag is not activated (S203:N), the address mapping manager 40 may allocate the generated virtual block address to the corresponding logical address, and update the address mapping table storage 400 (S209) by mapping a physical address.

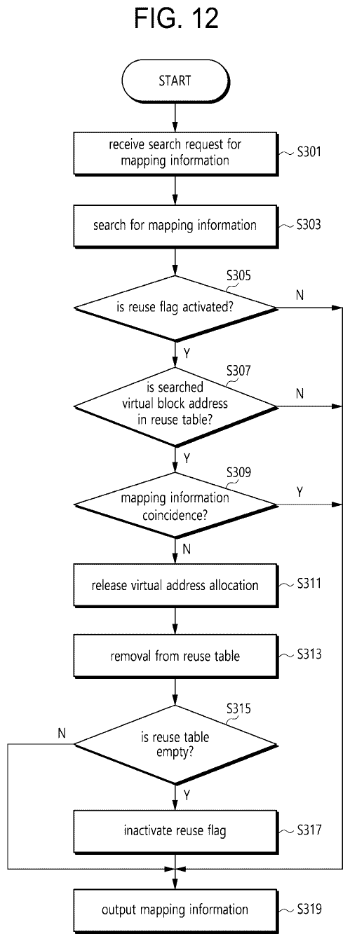

FIG. 12 is a flowchart explaining a virtual address processing process performed in a read operation.

In response to a search request for the mapping information corresponding to a logical address of data to be read (S301), the address mapping manager 40 may search for mapping information corresponding to the logical address to be read, for example, a virtual block address and a physical address (S303).

The address mapping manager 40 may confirm whether or not the reuse flag is activated (S305). The reuse flag confirming process (S305) may be omitted in a mode in which the reuse flag is not used, in which case the process may proceed directly from S303 to S307.

When it is confirmed that the reuse flag is not activated (S305:N), the address mapping manager 40 may output the searched mapping information (S319).

When it is confirmed that the reuse flag is activated (S305:Y), the address mapping manager 40 may confirm whether or not the searched virtual block address is registered in the reuse table (S307).

When it is confirmed that the virtual block address corresponding to the logical address to be read is not registered in the reuse table (S307:N), the address mapping manager 40 may output the searched mapping information (S319).

When it is confirmed that the virtual block address corresponding to the logical address to be read is registered in the reuse table (S307:Y), the address mapping manager 40 may confirm that the logical address to be read coincides with the logical address mapped to the virtual block address of the reuse table (S309).

When it is confirmed that no logical address stored in the logical address field of the reuse table exists or the stored logical address is different from the logical address to be read and the mapping information does not coincide (S309:N), the address mapping manager 40 may access the address mapping table storage 400 according to the logical address to be read and the virtual block address and store a specific value in the valid tag UNC field of the LV entry LVE related to the logical address to be read to release the virtual address allocation (S311), and delete the virtual block address from the reuse table 430 (S313).

After deleting the virtual block address from reuse table 430, the address mapping manager 40 may confirm whether or not the reuse table 430 is empty (S315). When it is confirmed that the reuse table 430 is empty (S315:Y), the address mapping manager 40 may inactivate the reuse flag (S317), and output the search mapping information (S319). When it is confirmed that the reuse table is not empty (S315:N), the address mapping manager 40 may maintain the reuse flag and output the searched mapping information (S319).

When it is confirmed that the logical address stored in the logical address field of the reuse table coincides with the logical address to be read (S309:Y), the address mapping manager 40 may determine that the virtual block address is reused, maintain the virtual block address of the reuse table, and output the searched mapping information (S319).

The virtual block address of the UECC-failed page may be registered in the reuse table and immediately reused, and thus the virtual addresses sequentially allocated in a fixed range may be efficiently reused.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications are obvious in view of the present disclosure and are intended to fall within the scope of the appended claims.

What is claimed is:

1. A data storage apparatus comprising:
a memory device; and
a memory controller configured to control the memory device,
wherein the memory controller includes an address mapping manager configured to:
access the memory device based on an address mapping table including a logical-virtual address table and a virtual-physical address table, and
when an error occurs in a first page of the memory device:
search for a virtual block address related to the first page with reference to the virtual-physical address table without accessing the logical-virtual address table, and
register a virtual address including a searched virtual block address in a reuse table.

2. The data storage apparatus of claim 1, wherein the address mapping manager is configured to:
generate a first virtual address corresponding to a first logical address of data to be written in the memory device, the first virtual address comprising a pair consisting of a first virtual block address and a first physical page address,
store the first virtual address in the logical-virtual address table by allocating the first virtual address to the first logical address when a logical address is not allocated to the first virtual address, and
store the first virtual block address in the virtual-physical address table by mapping the first virtual block address to a first physical block address.

3. The data storage apparatus of claim 2, wherein when the first virtual address is registered in the reuse table, the address mapping manager is configured to allocate the first virtual address to the first logical address, map the first virtual address and the first logical address, and store a mapping result in the reuse table.

4. The data storage apparatus of claim 1, wherein when a second virtual address corresponding to a second logical address of data to be read from the memory device is registered in the reuse table, the address mapping manager is configured to:
read a third logical address mapped to the second virtual address from the reuse table,
access the logical-virtual address table to release allocation of a virtual address allocated to the second logical address when the third logical address does not coincide with the second logical address, and
delete the second virtual address and information related thereto from the reuse table.

5. The data storage apparatus of claim 4, wherein when the third logical address coincides with the second logical address, the address mapping manager is configured to maintain the second virtual address and the information related thereto in the reuse table.

6. The data storage apparatus of claim 1, wherein when the virtual address is registered in the reuse table, the address mapping manager is configured to activate a reuse flag.

7. The data storage apparatus of claim 6, wherein when all virtual addresses registered in the reuse table are deleted, the address mapping manager is configured to inactivate the reuse flag.

8. A memory controller comprising:
an address mapping table storage including a logical-virtual address table, a virtual-physical address table, and a reuse table;
an address conversion circuit configured to:
generate a first virtual address corresponding to a first logical address of data to be written in a memory device, the first virtual address comprising a pair consisting of a first virtual block address and a first physical page address,
store the first virtual address in the logical-virtual address table by mapping the first virtual address to the first logical address when a logical address is not allocated to the first virtual address, and
store the first virtual block address in the virtual-physical address table by mapping the first virtual block address to a first physical block address; and
a reuse circuit configured to:
receive an error physical block address of the memory device,
search for an error virtual block address mapped to the error physical block address with reference to the virtual-physical address table without accessing the logical-virtual address table, and
register an error virtual address including a searched error virtual block address in the reuse table.

9. The memory controller of claim 8, wherein when the first virtual address is registered in the reuse table, the reuse circuit is configured to allocate the first virtual address to the first logical address, map the first virtual address and the first logical address, and store a mapping result in the reuse table.

10. The memory controller of claim 8, wherein when a second virtual address corresponding to a second logical address of data to be read from the memory device is registered in the reuse table, the reuse circuit is configured to:
read a third logical address mapped to the second virtual address from the reuse table,
access the logical-virtual address table to release allocation of a virtual address allocated to the second logical address when the third logical address does not coincide with the second logical address, and
delete the second virtual address and information related thereto from the reuse table.

11. The memory controller of claim 10, wherein when the third logical address coincides with the second logical address, the reuse circuit is configured to maintain the second virtual address and the information related thereto in the reuse table.

12. The memory controller of claim 8, wherein when the virtual address is registered in the reuse table, the reuse circuit is configured to activate a reuse flag.

13. The memory controller of claim 12, wherein when all virtual addresses registered in the reuse table are deleted, the reuse circuit is configured to inactivate the reuse flag.

14. An operating method of a data storage apparatus including a memory device and a memory controller configured to access the memory device based on an address mapping table including a logical-virtual address table and a virtual-physical address table, the method comprising:
the memory controller searching for, when an error occurs in a first page of the memory device, a virtual block address related to the first page with reference to the virtual-physical address table without accessing the logical-virtual address table; and
the memory controller registering a virtual address including a searched virtual block address in a reuse table.

15. The method of claim 14, further comprising:
the memory controller generating a first virtual address corresponding to a first logical address of data to be written in the memory device, the first virtual address comprising a pair consisting of a first virtual block address and a first physical page address;
the memory controller, when a logical address is not allocated to the first virtual address, storing the first virtual address in the logical-virtual address table by allocating the first virtual address to the first logical address; and
the memory controller storing the first virtual block address in the virtual-physical address table by mapping the first virtual block address to a first physical block address, and.

16. The method of claim 15, wherein allocating the first virtual address to the first logical address includes:
when the first virtual address is registered in the reuse table, allocating the first virtual address to the first logical address; and
mapping the first virtual address and the first logical address and storing a mapping result in the reuse table.

17. The method of claim 14, further comprising; when a second virtual address corresponding to a second logical address of data to be read from the memory device is registered in the reuse table,
the memory controller reading a third logical address mapped to the second virtual address from the reuse table;
the memory controller accessing the logical-virtual address table to release allocation of a virtual address allocated to the second logical address when the third logical address does not coincide with the second logical address; and
the memory controller deleting the second virtual address and information related thereto from the reuse table.

18. The method of claim 17, further comprising the memory controller maintaining the second virtual address and the information related thereto in the reuse table when the third logical address coincides with the second logical address.

19. The method of claim 14, wherein when the virtual address is registered in the reuse table, the memory controller is configured to activate a reuse flag.

20. The method of claim 19, wherein when all virtual addresses registered in the reuse table are deleted, the memory controller is configured to inactivate the reuse flag.

21. The method of claim 14, wherein when the virtual address related to the first page is registered in the reuse table, the memory controller does not register a logical address related to the first page in the reuse table.
